(19) United States
(12) Patent Application Publication
(10) Pub. No.: US 2026/0355615 A1
(43) Pub. Date: Nov. 12, 2026

(54) INTERACTIVE MAGNETIC FLIP DEVICE

(71) Applicant: Flips LLC, Montecito, CA (US)

(72) Inventor: Andrew Thomas Holt, Montecito, CA (US)

(73) Assignee: Flips LLC, Montecito, CA (US)

(21) Appl. No.: 19/669,556

(22) Filed: May 6, 2026

Related U.S. Application Data
(60) Provisional application No. 63/801,634, filed on May 7, 2025.

(51) Int. Cl. A63F 7/00; H01F 7/02

(52) U.S. Cl. CPC A63F 7/0088; H01F 7/0221; H01F 7/0242

(57) ABSTRACT

An interactive magnetic toy is shown and described. The magnetic toy includes a base and at least one freeform top piece. The base and top piece contain one or more magnets. The base can be any shape, such as a circle, oval, figure 8, clover, squared circle, square, or any other desirable shape, while the top piece similarly be in any geometric shape such as an oval or circle. The top piece contains one or more ball bearings on the bottom surface, thereby allowing the top piece to roll on its own or within the base.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/801,634, filed on May 7, 2025, with inventor(s) Andrew Thomas Holt, entitled “Flip Magnet Device and Toy,” attorneys'docket number 307.0001USP1.

### BACKGROUND OF THE INVENTION

### 1. Field of the Invention.

The present invention relates generally to interactive toys, and in particular, to an interactive magnetic device/toy.

### 2. Description of the Related Art.

Magnets have been incorporated into a number of toys and games. They are particularly desirable due to the ability of users to experience the magnetic attraction and repulsion forces when manipulating magnets with their hands. It is desirable to provide magnetic toys and games that allow a user to directly experience the magnetic attraction and repulsion forces.

Separately, toys that allow the user to manipulate objects in repetitive and/or new interesting ways involving some level of skill and practice have become very desirable. Much of this enjoyment is derived from the feeling of flipping and spinning objects in the air, and having them land in particular ways. For instance, toys such as yo-yo and kendama have been popular for quite some time, due to the feeling of mastery and skill users experience while using them.

Additionally, board sports such as skateboarding, snowboarding, and surfing are popular recreational activities enjoyed by people of all ages. However, these sports often require specialized equipment, dedicated spaces, athletic skill, and can pose safety risks. There exists a desire for a more accessible and safer way to experience the thrill and creativity of these sports.

In addition, fidget toys (e.g., small objects used for pleasant activities with the hands (manual fidgeting or stimming)) have become popular. Some users believe fidget toys help users tolerate anxiety, frustration, agitation, boredom, and excitement. Fidget toys are commonly used by those with sensory difficulties (e.g., in therapeutic, educational, or normal settings). A variety of different types of fidget toys have existed over the years (e.g., worry beads, Baoding balls, fidget spinners, fidget cubes, stress palls, pop its, etc.). It is desirable to have a new and different type of fidget toy.

### SUMMARY OF THE INVENTION

Embodiments of the invention combine the desirability of magnets, skill toys, fidget toys, and board sports by providing a novel and engaging toy that allows users to perform a variety of board sport tricks in a compact and safe manner. The toy comprises a base, which can be shaped like a miniature skate park, and a separate piece, which can be shaped like a miniature skateboard and contain small ball bearings that simulate a skateboard board rolling or a snowboard sliding on a surface.

One aspect of the invention's functionality is the strategic placement of magnets within both the base and the top piece. Users can manipulate the top piece, flipping, spinning, and sliding it across the base. The magnetic forces then guide the top piece back to its original position or towards designated landing zones within the base, simulating various board tricks and creating a feeling of skill and dynamic movement.

An additional feature of this invention is its portability. Designed to be easily held and played in the palm of the hand, the toy can be enjoyed virtually anywhere, from waiting rooms and classrooms/educational settings to parks and playgrounds. This portability significantly enhances the accessibility and convenience of the toy, making it suitable for a wide range of users and environments.

### BRIEF DESCRIPTION OF THE DRAWINGS

Referring now to the drawings in which like reference numbers represent corresponding parts throughout:

FIG. 1 shows an isometric view of an embodiment of the magnetic toy, including the base and top piece in accordance with one or more embodiments of the invention;

FIG. 2 shows an isometric view of an embodiment of the magnetic toy of FIG. 1, wherein only the base is shown in accordance with one or more embodiments of the invention;

FIG. 3 shows a perspective of an embodiment of the magnetic toy of FIG. 1, showing the bottom of the base in accordance with one or more embodiments of the invention;

FIG. 4 shows a perspective of an embodiment of the magnetic toy of FIG. 1, showing the inside of the bottom of the base in accordance with one or more embodiments of the invention;

FIG. 5 shows a perspective of an embodiment of the magnetic toy of FIG. 1, showing the underside of the top of the base and the magnets enclosed therein in accordance with one or more embodiments of the invention;

FIG. 6 shows a perspective of an embodiment of the magnetic toy of FIG. 1, showing the inside of the bottom of the base and the sound-reducing part enclosed therein in accordance with one or more embodiments of the invention;

FIG. 7 shows an isometric view of an embodiment of the top piece of the magnetic toy of FIG. 1 in accordance with one or more embodiments of the invention;

FIG. 8 shows a perspective of an embodiment of the magnetic toy of FIG. 1, showing the bottom of the top piece in accordance with one or more embodiments of the invention;

FIG. 9 shows a perspective of an embodiment of the magnetic toy of FIG. 1, showing the underside of the top portion of the top piece and the magnets and balls enclosed therein in accordance with one or more embodiments of the invention;

FIG. 10 shows a perspective of an embodiment of the magnetic toy of FIG. 1, showing the inside of the bottom of the top piece and the balls enclosed therein in accordance with one or more embodiments of the invention;

FIG. 11 shows an isometric view of an embodiment of the magnetic toy of FIG. 1, showing the polarity of the top sides of the magnets enclosed within the base and top piece, and one possible starting position of the top piece within the base in accordance with one or more embodiments of the invention;

FIG. 12 shows an isometric view of an embodiment of the magnetic toy of FIG. 1, showing the possible direction of movement of the top piece when manipulated by the user in accordance with one or more embodiments of the invention;

FIG. 13 shows an isometric view of an embodiment of the magnetic toy of FIG. 1, showing the polarity of the top sides of the magnets enclosed within the base and top piece, one possible starting position of the top piece before it is flipped upward by the user, and the two primary directions the top piece can rotate when flipped upward from the base by the user in accordance with one or more embodiments of the invention;

FIG. 14 shows an isometric view of an embodiment of the magnetic toy of FIG. 1, showing the polarity of the top side of the magnets enclosed within the base and the polarity of the bottom side of the magnet enclosed within the top piece, the two primary directions of rotation of the top piece, and the two locations the top piece will land due to magnetic attraction between the negative polarity of the magnet in the top piece and positive polarity of the magnets in the bottom piece in accordance with one or more embodiments of the invention;

FIG. 15 shows an isometric view of an embodiment of the magnetic toy of FIG. 1, showing the polarity of the top sides of the magnets enclosed within the base and top piece, and one possible ending position of the top piece within the base after it has flipped in the air in accordance with one or more embodiments of the invention;

FIG. 16 shows a perspective of an embodiment of the magnetic toy of FIG. 1 being used by a human hand, showing a method of initiating a flipping motion by positioning the top piece up the side lip of the base and pressing down on one edge of the top piece in accordance with one or more embodiments of the invention;

FIG. 17 shows a perspective of an embodiment of the magnetic toy of FIG. 1 being used by a human hand, showing the top piece flipping in motion in accordance with one or more embodiments of the invention; and

FIG. 18 is the logical flow for using the interactive magnet device in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

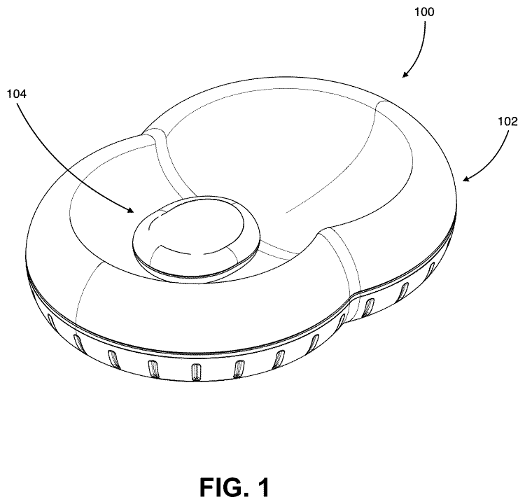

FIGS. 1-17 illustrate exemplary embodiments of a magnetic toy in accordance with one or more embodiments of the invention. FIG. 1 shows an isometric view of an embodiment of the magnetic toy, including the base and top piece in accordance with one or more embodiments of the invention. As illustrated, there is provided a magnetic toy 100 that consists of a single base 102 and at least one freeform top piece 104, both of which contain one or more magnets. The toy can be held in one hand or two, depending on preference. The purpose of the toy is to move the top piece 104 around the base 102 in various ways while feeling the magnetic attraction between the magnets in the base and the magnet in the top piece, and causing the top piece 104 to flip, fly, or move from one part of the base 102 to another.

The base 102 can be any shape, such as a circle, oval, figure eight (8)/8-shaped object, clover, squared circle, square, bilobed, double-bowl, kidney-like, concave spheroid, or any other desirable shape, and can consist of various sizes of the same shape.

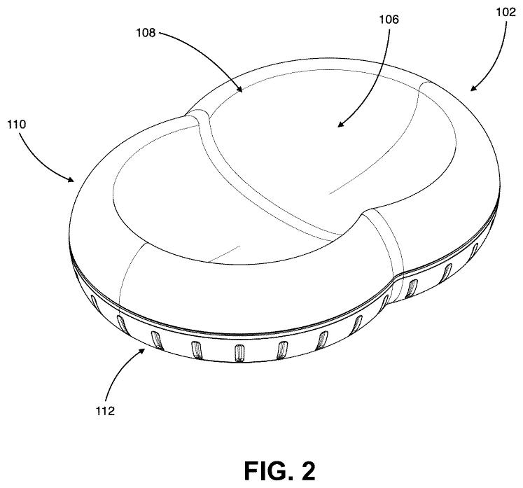

FIG. 2 shows an isometric view of an embodiment of the magnetic toy of FIG. 1, wherein only the base is shown in accordance with one or more embodiments of the invention. As illustrated, the base 102 features a concave face 106 on top that forms a lip around the edge 108 of the shape.

The base 102 may be made of various materials, including thermoplastic, and be textured in various ways. In one or more embodiments, the construction of the base 102 consists of two separate pieces 110-112 that combine to form the base 102, such that the magnets 116 may be added during assembly. The separate pieces 110-112 may be combined using ultrasonic welding, latches, glue, snapping mechanisms, or other techniques.

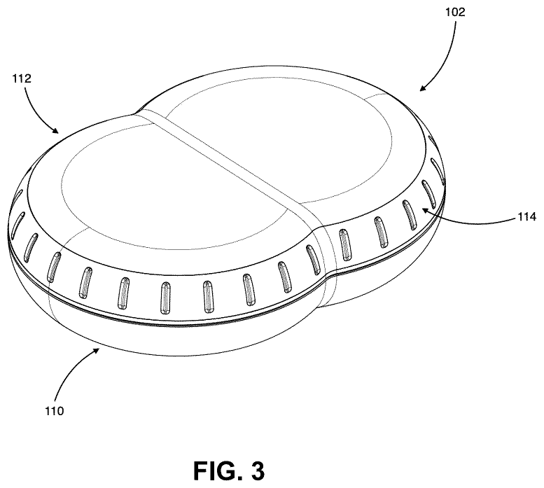

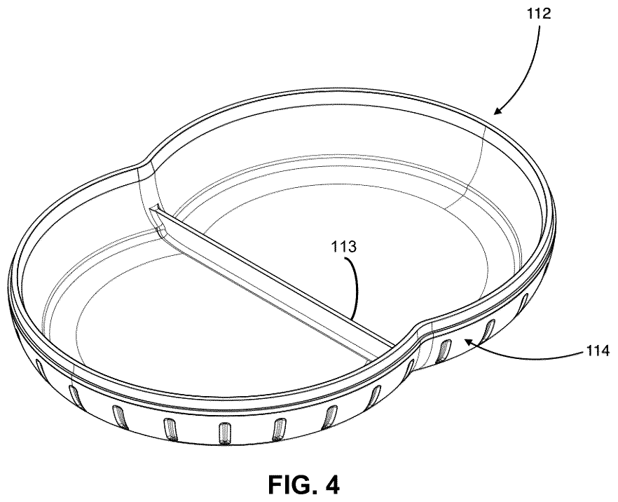

FIG. 3 shows a perspective of an embodiment of the magnetic toy of FIG. 1, showing the bottom of the base in accordance with one or more embodiments of the invention. FIG. 4 shows a perspective of an embodiment of the magnetic toy of FIG. 1, showing the inside of the bottom of the base in accordance with one or more embodiments of the invention. Referring to FIGS. 3 and 4, in one or more embodiments, the bottom part of the base 112 may feature a thermoplastic elastomer strip 114.

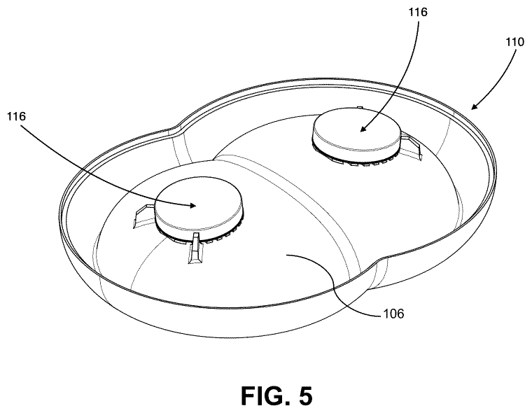

FIG. 5 shows a perspective of an embodiment of the magnetic toy of FIG. 1, showing the underside of the top of the base and the magnets enclosed therein in accordance with one or more embodiments of the invention. As illustrated in FIG. 5, the base 110 contains one or more magnets 116 at various points underneath the concave face 106.

FIG. 6 shows a perspective of an embodiment of the magnetic toy of FIG. 1, showing the inside of the bottom of the base and the sound-reducing part enclosed therein in accordance with one or more embodiments of the invention. As illustrated in FIG. 6, the bottom part of the base 112 may also contain a molded thermoplastic elastomer part 118 to add weight and reduce sound produced when the freeform top piece 104 makes contact with the base 102.

Further, as illustrated in FIGS. 1-6 (and as described above), the shape of base 102 may be referred to as a bilobed, double-bowl, kidney-like, 8-shaped object, or concave spheroid. Such a shape enables different types of tricks, flips, rotations, etc. of the freeform top piece 104 as it moves from one part of the base 102 to another (e.g., from one of the separate base parts [e.g., one end of the base 102] to the other base part [e.g., to the other end of the base 102]). In other words, as long as the base 102 is concave, the overall shape of base 102 may be round, square, oval, rectangular, kidney-like, or any other shape that enables the freeform top piece 104 to move and be manipulated within the convex shape.

Further to the above, two separate base parts that are concave and semi-spherical may be joined together to form the top and bottom of the base 102. During construction, a cross-bar 113 such as that illustrated in FIG. 4 may be utilized to provide structural integrity, weight, or to enable the top and bottom parts of the base 102 to be secured to each other.

The freeform top piece 104 can be any shape, such as a circle, squared circle, oval, or any other desirable shape.

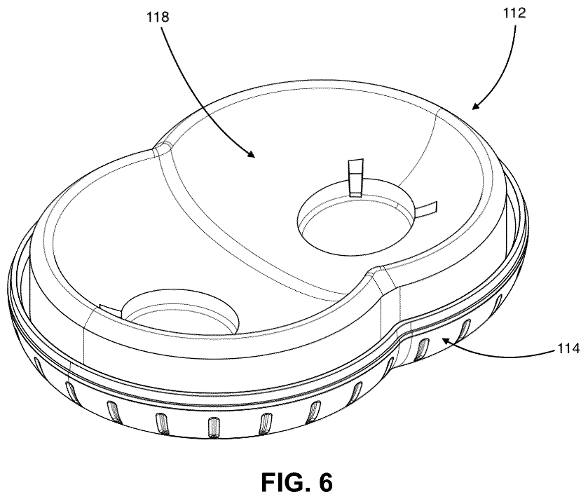

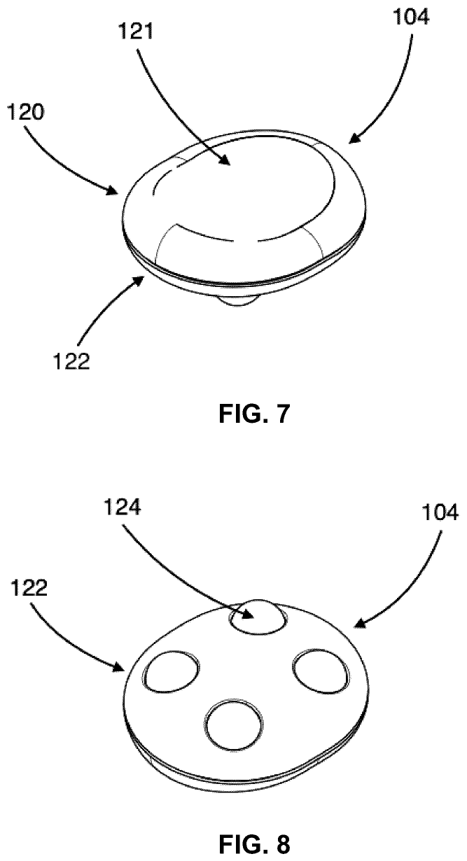

FIG. 7 shows an isometric view of an embodiment of the top piece of the magnetic toy of FIG. 1 in accordance with one or more embodiments of the invention. As illustrated in FIG. 7, the top piece 104 may be made of various materials, including thermoplastic, and be textured in various ways. In one or more embodiments, the construction of the top piece 104 consists of two separate pieces 120 and 122 that combine to form the freeform top piece 104, such that a magnet 126 (not shown in FIG. 7) and ball bearings 124 (not shown in FIG. 7) may be added during assembly. The separate pieces 120 and 122 may be combined using ultrasonic welding, glue, snap mechanism, or other techniques. The top of the freeform top piece 120 may feature a convex area 121, which can feature a texture, possibly a rubberized textured insert to aid in grip and add a tactile element.

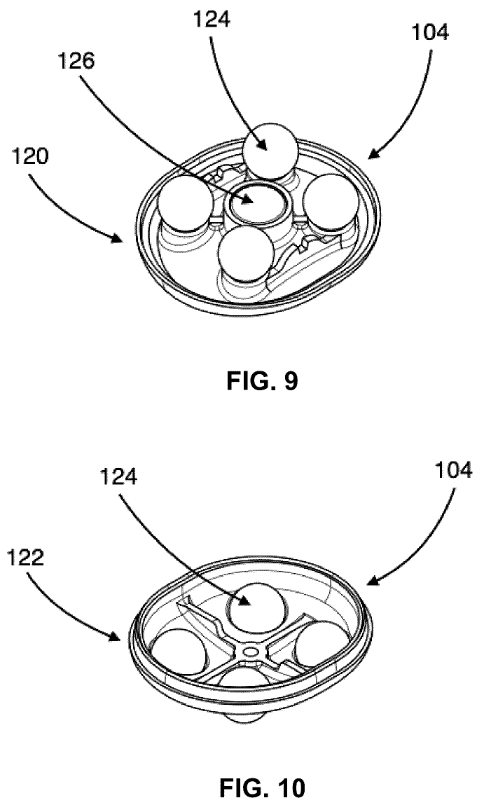

FIG. 8 shows a perspective of an embodiment of the magnetic toy of FIG. 1, showing the bottom of the top piece 104 in accordance with one or more embodiments of the invention. FIG. 9 shows a perspective of an embodiment of the magnetic toy of FIG. 1, showing the underside of the top portion of the top piece 104 and the magnets 126 and balls/ball bearings 124 enclosed therein in accordance with one or more embodiments of the invention. FIG. 10 shows a perspective of an embodiment of the magnetic toy of FIG. 1, showing the inside of the bottom of the top piece 104 and the balls/ball bearings 124 enclosed therein in accordance with one or more embodiments of the invention. Referring to FIGS. 8, 9, and 10, the bottom 122 of the freeform top piece 120 may feature a convex shape, in which one or more ball bearings 124 are embedded. The ball bearings 124 allow the top piece to roll across the surface of the base 102 or other surfaces. There may be any number of ball bearings 124 to allow for different styles of play or different tricks. Referring to FIG. 9, one or more magnets 126 are embedded within the freeform top piece 104.

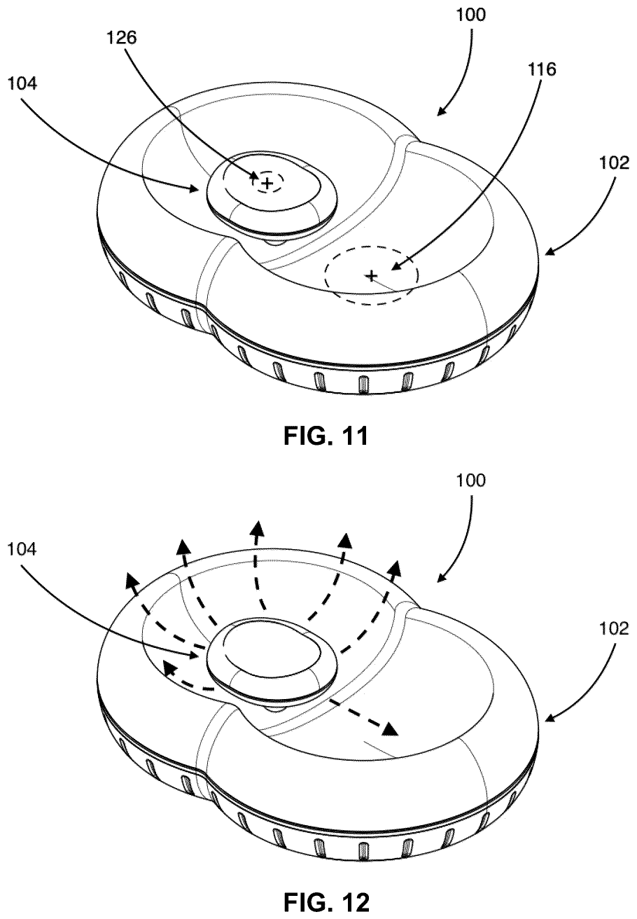

The primary way to use the toy is to place the freeform top piece 104 within the base 102, where the top of the magnets 116 in the base 102 have an opposite polarity (+/−) than the bottom of the magnet 126 in freeform top piece 104 as shown in FIG. 11, creating a magnetic attraction and keeping the freeform top piece 104 in place. In this regard, the polarity (+/−) of magnets 116 and 126 control the force felt by the user when manipulating/moving the freeform top piece 104 with respect to the base 102. Thus, FIG. 11 shows an isometric view of an embodiment of the magnetic toy of FIG. 1, showing the polarity of the top sides of the magnets 116 and 126 enclosed within the base 102 and top piece 104, and one possible starting position of the top piece 104 within the base 102 in accordance with one or more embodiments of the invention.

FIG. 12 shows an isometric view of an embodiment of the magnetic toy of FIG. 1, showing the possible direction of movement of the top piece 104 when manipulated by the user in accordance with one or more embodiments of the invention. As shown in FIG. 12, the user may then manipulate the top piece 104 within the concave surface of the base 102, possibly moving between the base magnets 116 (if there is more than one magnet 116) or moving the freeform top piece 104 up the side lip of the base 102. While there are many ways to play with the top piece 104 within the base 102, a common method is for the user to hold the base 102 in the plan of a hand while moving the freeform top piece 104 with the thumb of the same hand. Due to the magnetic attraction between the magnets in the base 102 and the freeform top piece 104, the freeform top piece 104 will snap to one of the magnets in the base 102 when released. In this manner, the user can move the freeform top piece 104 all around the base 102, feeling the magnetic attraction change as the piece moves, and snap the freeform top piece 104 around between various positions of the base 102.

In certain positions, it is possible for the user to cause the freeform top piece 104 to flip, spin, or move through the air in interesting ways by releasing the freeform top piece 104 in specific ways along the top of the base surface, with the freeform top piece 104 landing back within the base 102. The freeform top piece 104 can in this manner can perform a variety of tricks that are enjoyable to watch, perform, and master. The freeform top piece 104 spins and flips due to the nature of the magnetic field created between the magnets 116 and 126. For example, as shown in FIGS. 12 to 14, when the freeform top piece 104 is initially flipped into the air off of the lip 108, the magnet 126 will experience a torque force caused by the magnetic field created between itself and magnets 116 in the base 102. This force tries to align the magnetic fields (i.e., the torque force interacts with the magnetic fields), resulting in a rotational motion of the freeform top piece 104. This rotational motion can be along many axes depending on the initial angle of spin when the freeform top piece 104 is first flipped by the user; the magnetic field can either keep the freeform top piece 104 spinning in its initial direction, or change and reverse the rotation. Flipping the freeform top piece 104 in this manner requires some practice and skill, as initiating the flip takes practice, and the top piece 104 can fly out of the base if not initiated correctly. This results in a sense of dynamic motion and mastery that simulates the variety of tricks available in sports such as skateboarding.

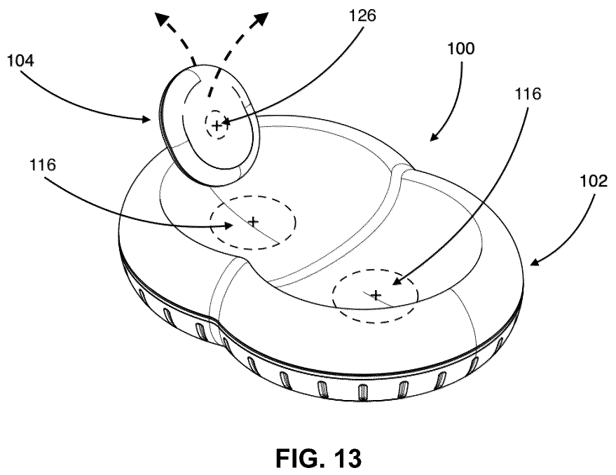

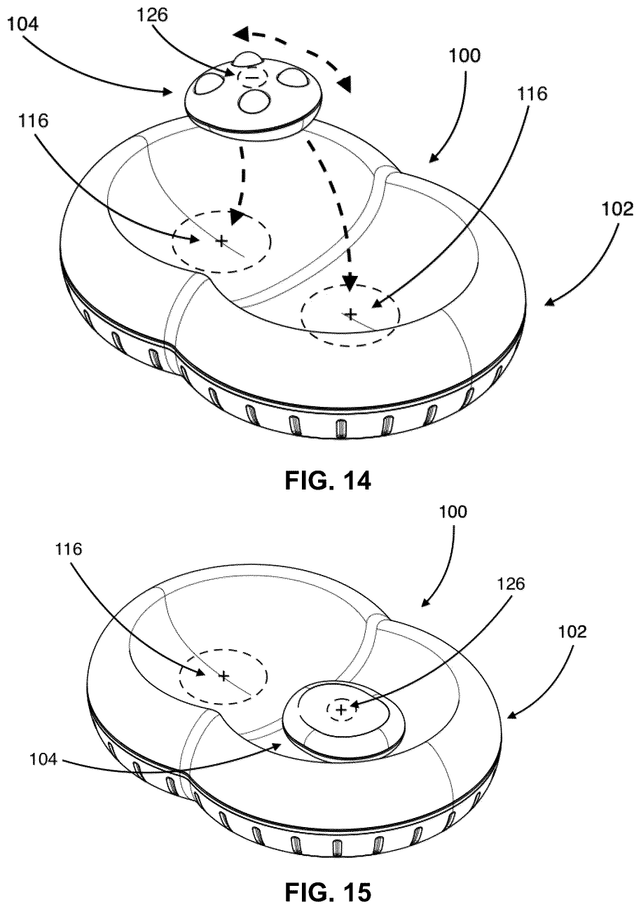

In view of the above, FIG. 13 shows an isometric view of an embodiment of the magnetic toy of FIG. 1, showing the polarity of the top sides of the magnets enclosed within the base and top piece, one possible starting position of the top piece before it is flipped upward by the user, and the two primary directions the top piece can rotate when flipped upward from the base by the user in accordance with one or more embodiments of the invention. FIG. 14 shows an isometric view of an embodiment of the magnetic toy of FIG. 1, showing the polarity of the top side of the magnets 116 enclosed within the base 102 and the polarity of the bottom side of the magnet 126 enclosed within the top piece 104, the two primary directions of rotation of the top piece 104, and the two locations the top piece 104 will land due to magnetic attraction between the negative polarity of the magnet 126 in the top piece 104 and positive polarity of the magnets 116 in the bottom piece/base 102 in accordance with one or more embodiments of the invention. Further, FIG. 15 shows an isometric view of an embodiment of the magnetic toy of FIG. 1, showing the polarity of the top sides of the magnets 116 and 126 enclosed within the base 102 and top piece 104, and one possible ending position of the top piece 104 within the base 102 after it has flipped in the air in accordance with one or more embodiments of the invention;

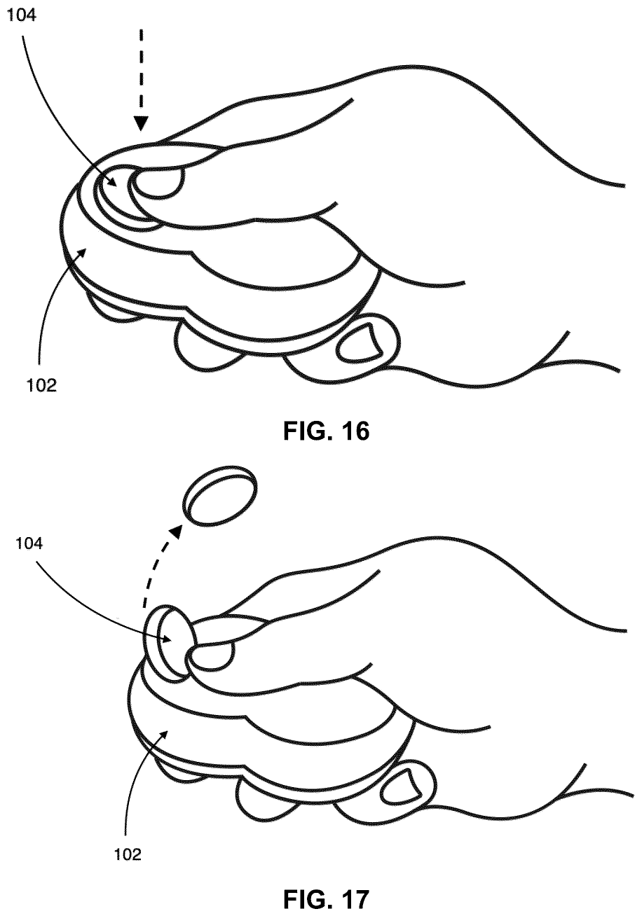

Further to the above, FIG. 16 shows a perspective of an embodiment of the magnetic toy of FIG. 1 being used by a human hand, showing a method of initiating a flipping motion by positioning the top piece 104 up the side lip of the base 102 and pressing down on one edge of the top piece 104 in accordance with one or more embodiments of the invention. In addition, FIG. 17 shows a perspective of an embodiment of the magnetic toy of FIG. 1 being used by a human hand, showing the top piece 104 flipping in motion in accordance with one or more embodiments of the invention.

### Logical Flow

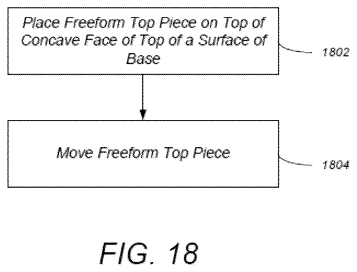

FIG. 18 is the logical flow for using the interactive magnet device in accordance with one or more embodiments of the invention.

At step 1802, a freeform top piece 104 is placed on top of a concave face of a top of a surface of a base 102. As described above, the base 102 contains one or more first magnets 116, the freeform top piece 104 contains one or more second magnets 126, the freeform top piece 104 makes contact with the concave face, and polarities of the one or more first magnets 116 and the one or more second magnets 126 form a magnetic attraction.

In one or more embodiments, the base 102 may be made of thermoplastic. Further, in one or more embodiments, the one or more first magnets 116 may be secured in between an upper base part and a lower base part of the base 102, and the upper base part may be secured to the lower base part (e.g., using ultrasonic welding).

In one or more additional embodiments, weight may be added to the base 102 using a molded component. Such a molded component reduces sound produced when the freeform top piece 104 makes contact with the base 102.

Further to the above, in one or more embodiments, the one or more second magnets 126 may be secured in place in between an upper top part and a lower top part of the freeform top piece 104, and the upper top part may be secured to the lower top part. In addition, one or more ball bearings that protrude out of the freeform top piece 104 may be utilized to roll/move the freeform top piece 104 across the concave face of the base 102.

At step 1802, the freeform top piece 104 is moved with respect to the base 102 based on input from a user. The magnetic attraction snaps the freeform top piece 104 to one or more positions based on locations of the one or more first magnets 116.

In one or more embodiments, the moving may be based on a manipulating/manipulation of the freeform top piece 104 with respect to a top of a surface of the base 102. In this regard, the freeform top piece 104 may flip, spin, or move through the air based on the manipulating and the magnetic attraction. Further, in one or more embodiments, the input from the user may consist of a user's fingers contacting and moving the freeform top piece 104 with respect to the base 102. In such embodiments, the freeform top piece 104 snaps to the one or more positions when the contact (of the user's fingers with the top piece) is released.

### Conclusion

This concludes the description of the preferred embodiment of the invention. The following describes some alternative embodiments for accomplishing the present invention. For example, the base 102 and freeform top piece 104 may be constructed of any type of material such as plastic, metal, thermoplastic, stone, glass, etc. In addition, the parts 110-112 of base 102 (and/or parts 120 and 122 of freeform top piece 104), may be secured to each other via a snap/release mechanism, glue, welding, etc. In this regard, the parts 110-112 of base 102 (and/or parts 120 and 122 of freeform top piece 104) may be permanently secured together or may be secured such that the user can separate the parts 110/112 and 120/122 to rearrange the magnets 116/126, replace the magnets 116/126 (e.g., with stronger/weaker magnets 116/126-magnets 116/126 having a different magnetic moment/flux), remove/replace the ball bearings 124, etc.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An interactive magnet device, comprising:
a base containing one or more first magnets, wherein a top of a surface of the base has a concave face;
a freeform top piece containing one or more second magnets, wherein the freeform top piece is placed on and makes contact with the concave face;
wherein:
polarities of the one or more first magnets and the one or more second magnets form a magnetic attraction;
the magnetic attraction snaps the freeform top piece to one or more positions based on locations of the one or more first magnets; and
the freeform top piece moves with respect to the base based on input from a user.

2. The interactive magnet device of claim 1, wherein:
the base is made of thermoplastic.

3. The interactive magnet device of claim 1, wherein:
the base comprises an upper base part and a lower base part;
the one or more first magnets are secured in place in between the upper base part and the lower base part; and
the upper base part is secured to the lower base part.

4. The interactive magnet device of claim 3, wherein:
the upper base part is secured to the lower base part using ultrasonic welding.

5. The interactive magnet device of claim 1, wherein:
the base comprises a molded component;
the molded component adds weight to the base; and
the molded component reduces sound produced when the freeform top piece makes contact with the base.

6. The interactive magnet device of claim 1, wherein:
the freeform top piece comprises an upper top part and a lower top part;
the one or more second magnets are secured in place in between the upper top part and the lower top part; and
the upper top part is secured to the lower top part.

7. The interactive magnet device of claim 1, wherein:
the freeform top piece further comprises one or more ball bearings that protrude out of the freeform top piece;
the one or more ball bearings enable the freeform top piece to roll across the concave face of the base.

8. The interactive magnet device of claim 1, wherein:
the freeform top piece comprises a texture that aids in grip.

9. The interactive magnet device of claim 1, wherein:
the freeform top piece is a convex shape.

10. The interactive magnet device of claim 1, wherein:
the freeform top piece is manipulated with respect to a top of a surface of the base;
the freeform top piece flips, spins, or moves through the air based on the input from the user and the magnetic attraction.

11. The interactive magnet device of claim 1, wherein:
the input from the user comprises a user's fingers contacting and moving the freeform top piece with respect to the base; and
the freeform top piece snaps to the one or more positions when the contact is released.

12. A method of using an interactive magnet device, comprising:
(a) placing a freeform top piece on top of a concave face of a top of a surface of a base, wherein:
(1) the base contains one or more first magnets;
(2) the freeform top piece contains one or more second magnets;
(3) the freeform top piece makes contact with the concave face;
(4) polarities of the one or more first magnets and the one or more second magnets form a magnetic attraction;
(b) moving the freeform top piece with respect to the base based on input from a user, wherein the magnetic attraction snaps the freeform top piece to one or more positions based on locations of the one or more first magnets.

13. The method of claim 12, wherein:
the base is made of thermoplastic.

14. The method of claim 12, further comprising:
securing the one or more first magnets in between an upper base part and a lower base part of the base; and
securing the upper base part to the lower base part.

15. The method of claim 14, wherein:
the upper base part is secured to the lower base part using ultrasonic welding.

16. The method of claim 12, wherein:
adding weight to the base using a molded component, wherein the molded component reduces sound produced when the freeform top piece makes contact with the base.

17. The method of claim 12, wherein:
securing the one or more second magnets in place in between an upper top part and a lower top part of the freeform top piece; and
securing the upper top part to the lower top part.

18. The method of claim 12, wherein:
utilizing one or more ball bearings that protrude out of the freeform top piece to roll the freeform top piece across the concave face of the base.

19. The method of claim 12, further comprising:
manipulating, the freeform top piece with respect to a top of a surface of the base, wherein the freeform top piece flips, spins, or moves through the air based on the manipulating and the magnetic attraction.

20. The method of claim 12, further comprising:
the input from the user comprises a user's fingers contacting and moving the freeform top piece with respect to the base; and
the freeform top piece snaps to the one or more positions when the contact is released.
